(19) United States
(12) Patent Application Publication
(10) Pub. No.: US 2002/0147065 A1
(43) Pub. Date: Oct. 10, 2002

(54) Tooth chain, in particular transport tooth chain

(75) Inventors: Klaus-Burkhard Winkelmann, Laatzen (DE); Georg Twardzik, Marienhagen (DE)

Correspondence Address: Henry M. Feiereisen, Suite 3220, 350 Fifth Avenue, New York, NY, 10118, US

(73) Assignee: REXROTH MECMAN GMBH, Hannover (DE)

(21) Appl. No.: 10/114,910

(22) Filed: Apr. 3, 2002

(30) Foreign Application Priority Data
Apr. 4, 2001 (DE) 101 16 806.3

(51) Int. Cl. F16G 13/04

(52) U.S. Cl. 474/215; 474/214; 474/212

(57) ABSTRACT

A tooth chain includes a plurality of links, each link having at least two spaced-apart apertures, and a plurality of pins received in the apertures for joining together the links to thereby define inner links and outer links. Each pin has a length which is sized to terminate within the aperture of the outer link, wherein the aperture has a cross sectional profile which corresponds to a cross sectional profile of a pin end at a slight clearance fit to leave a space sufficient to allow the pin end to be joined with a wall of the aperture, without projecting beyond an outer surface of the outer link.

### CROSS-REFERENCES TO RELATED APPLICATIONS

This application claims the priority of German Patent Application, Serial No. 101 16 806.3, filed Apr. 4, 2001, pursuant to 35 U.S.C. 119(a)-(d), the subject matter of which is incorporated herein by reference.

### BACKGROUND OF THE INVENTION

The present invention relates to a tooth chain, in particular a transport tooth chain.

Tooth chains involved here include a plurality of double-toed links which have at least two spaced-apart apertures to receive pins for joining together the links with adjacent outer links to form the inverted tooth chain. These types of chains are predominantly used in transport systems. A linear conveying path is realized by guiding the tooth chain, like a conveyor belt, about a drive sprocket and an idler sprocket at the ends of an elongate carrier frame. Hereby, the drive sprocket engages a complementary tooth space of the tooth chain. Such systems are typically employed in high-temperature environments, e.g. in production of hollow glasses. All components of the tooth chain are made of steel to reliably withstand the enormous temperatures.

German Pat. No. DE 198 44 304 C1 describes a tooth chain which includes several links disposed in two spans in parallel neighboring relationship and joined together by round bolts or cradle joints. Unlike a round bolt, a cradle joint is composed of two components, a rolling pin and a bearing pin. The bearing pin is riveted on one end with a rivet disk to hold the links together. Both profiled pins are held in apertures of the links and roll off one another as the jointed connection moves. In contrast to a bolt-type bearing, there is no sliding friction in the cradle joint so that wear is significantly reduced in this area. When connecting the links by round bolts, the round bolt is provided on each end with a retaining disk which engages a corresponding circumferential groove in the end zone of the round bolt. Particular transport functions can be realized, when the conventional tooth chain has various running rollers and accumulating rollers as further components. The accumulating rollers cooperate hereby with the goods to be transported whereas the running rollers correspond with a carrier frame.

Other chain conveyors are known which do not incorporate such additional components and use an elongate carrier frame with a slide bed for guiding the tooth chain. The slide bed includes essentially a flat bottom and two lateral upright sidewalls and is so sized that the tooth chain is laterally guided at slight clearance. This type of chain conveyor suffers shortcomings because the lateral chain guidance is subject to significant wear as the tooth chain advances. The bolts for pinning the links of the tooth chain together project out beyond the outer links and contact directly the sidewalls of the slide bed. The movement of the tooth chain leads in the contact zone with the sidewall of the slide bed to a material removal of the sidewall as well as of the tooth chain. This material removal of the tooth chain causes an abrading of the bolt ends and thus also of the riveting and ring-type retaining mechanism and will ultimately result in a disintegration of the tooth chain. The progressive wear of the guidance results in a steadily increasing gap between the sidewalls of the slide bed and the tooth chain, thereby more and more deteriorating the guidance so that the need of cumbersome maintenance works and repair works are the result.

Attempts have been made to configure the sidewalls of the slide bed with a recess to receive the portions of the bolts which jut out beyond the outer links so that the sidewall can cooperate directly with the outer link of the tooth chain. The decrease of the wearing action is, however, negated by the need to construct a more complicated and cost-intensive configuration of the slide bed. Moreover, the wearing areas on the slide bed are reduced to narrow surface bands which are subject to wear until ultimately the bolt ends contact the sidewall of the slide bed and wear out as well.

For a number of reasons, the various proposals and approaches are endowed with drawbacks and shortcomings relating, i.a., to manufacturing techniques or to the effect that is hoped to be obtained but may not always be realized.

It would therefore be desirable and advantageous to provide an improved tooth chain to obviate prior art shortcomings and to reduce the wearing tendency on the lateral guidance.

### SUMMARY OF THE INVENTION

According to one aspect of the present invention, a tooth chain includes a plurality of links, each link having at least two spaced-apart apertures; and a plurality of pins received in the apertures for joining together the links to thereby define inner links and outer links, whereby the pins and the apertures are placed into one-to-one correspondence, each pin having a length which is sized to terminate within the aperture of the outer link, wherein the aperture has a cross sectional profile which corresponds to a cross sectional profile of a pin end at a slight clearance fit to leave a space sufficient to allow the pin end to be joined with a wall of the aperture, without projecting beyond an outer surface of the outer link.

The present invention resolves prior art problems by so configuring the tooth chain that the pins are prevented from jutting out beyond the outer link. As a consequence, the entire surface of the outer link is available for lateral guidance of the tooth chain, thereby forming the conditions for attaining a minimum wear and a resultant longer service life of the tooth chain. By keeping the pin end within the space of the outer link, the pins can be securely fixed to the outer links as the links are joined so that the links of the tooth chain can be reliably held together. As a result, the tooth chain is especially suitable for a transport function and exhibits smooth and flat side surfaces which are defined by the outer links and have a useful transport width which corresponds to the overall width, whereby the tooth chain can travel in a corresponding slide bed at little play. Thus, the slide bed can be configured with a minimum overwidth with respect to the tooth chain and is easy to fabricate with flat and smooth sidewalls. A large-area contact is attained between the side surfaces of the tooth chain and the sidewalls of the slide bed, without experiencing a high surface pressure. Material removal per time unit is thus very slight in the contact zone for implementing the guiding function. In view of the fact that a noticeable enlargement of the narrowly adjustable lateral gap clearance would require a significant material removal on both sides through wear, the presence of only a minimal wearing action in a tooth chain according to the present invention results constant operating conditions of the tooth chain over a long time period. Compared to conventional tooth chains with rivet heads or ring retainers, a tooth chain according to the present invention has a much longer useful life as a consequence of the recessed disposition of the pins inside the outer link, and is maintained only when wear ultimately jeopardizes the connection between the pins and the outer links as a result of material removal.

According to another feature of the present invention, the outer links may be configured thicker in width than the inner links so as to maximize the available effective depth of the space for joining the pins with the outer links. Through suitable dimensioning, the required strength of the connection between the outer link and the pin can be determined through tests or calculation on the basis of the selected joining technique and load of the tooth chain.

Welding or riveting may suitably be used to join the pins with the outer links. In view of the tight space conditions, only special welding or riveting techniques may, however, be applicable. In case of welding, it may be advisable to employ laser welding in order to join the pins with the outer links, whereby the weld seam may have an intermittent or closed configuration. In the event of an intermittent weld seam and depending on load parameters of the tooth chain, the connection of the pins and the outer links may be realized by at least one welding spot or at least a weld seam section within the space of the outer link. Higher load on the tooth chain may require the application of a ring-shaped closed weld seam within the space.

According to another feature of the present invention, the weld seam may have a substantially triangular cross section and be defined by a first weld seam side, which interacts with an end face of the pin end, and a second weld seam side, which is disposed perpendicular to the first weld seam side and interacts with the wall of the aperture. Such a weld seam configuration enables an effective exploitation of the tight wall area within the space for realizing a connection of the pins with the outer links while attaining a highest possible strength.

According to another feature of the present invention, the pin end can be joined with the outer link by a particular riveting process in the form of a graining, by which a pointed punch is used to hammer a conical depression in the pin, resulting in an edge widening of the pin end to form a press fit with the wall of the aperture. Graining should hereby be applied centrally onto the end face of the pin end to maximize the strength of the press fit through an even edge widening. The joint may additionally be secured by a subsequent sealing of the space with epoxy resin or the like.

According to another feature of the present invention, the pin end may be provided with a shoulder or abutment to define the penetration depth of the pin end in the aperture of the outer link. In this way, assembly of the tooth chain is simplified and ensures a same quality of the selected joining operation.

According to another feature of the present invention, the pin may be a round bolt or a hinge bolt or any other configuration known to the artisan, depending on the construction of the tooth chain. Of course, a combination of round bolt and hinge bolt may also be conceivable within one and the same tooth chain. For example, when the tooth chain is provided with integral running rollers and/or accumulating rollers, the pins may be configured in the form of round bolts which simultaneously serve as axle for the running rollers and/or accumulating rollers.

According to another aspect of the present invention, a chain conveyor includes a driving sprocket; an elongate carrier frame forming a slide bed which includes a flat bottom and two lateral upright sidewalls; and an endless tooth chain wrapped about the driving sprocket and guided in the slide bed of the carrier frame, wherein the tooth chain includes plural links, each link having at least two spaced-apart apertures, and plural pins received in the apertures for joining together the links to thereby define an inner link and an outer link, whereby the pins and the apertures are placed into one-to-one correspondence, each said pin having a length which is sized to terminate within the aperture of the outer link on both sides, wherein the aperture has a cross sectional profile which corresponds to a cross sectional profile of a pin end at a slight clearance fit to leave a space sufficient to allow the pin end to be joined with a wall of the aperture without projecting beyond an outer surface of the outer link, wherein the sidewalls of the carrier frame are configured to correspond to the outer links of the tooth chain.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross sectional illustration of a chain conveyor having incorporated therein a tooth chain according to the present invention;

FIG. 2 is a side view of the tooth chain of FIG. 1;

FIG. 3 is a detailed side view of an outer link of the tooth chain;

FIG. 4 is a cutaway sectional view of the outer link, taken along the line IV-IV in FIG. 3;

FIG. 5 is a fragmentary view of an exemplified pin in the form of a hinge bolt, whereby the outer link is removed; and

FIG. 6 is a fragmentary view of an exemplified pin in the form of a round bolt.

### DETAILED DESCRIPTION OF PREFERRED EMBODIMENTS

Throughout all the FIGURES same or corresponding elements are generally indicated by same reference numerals.

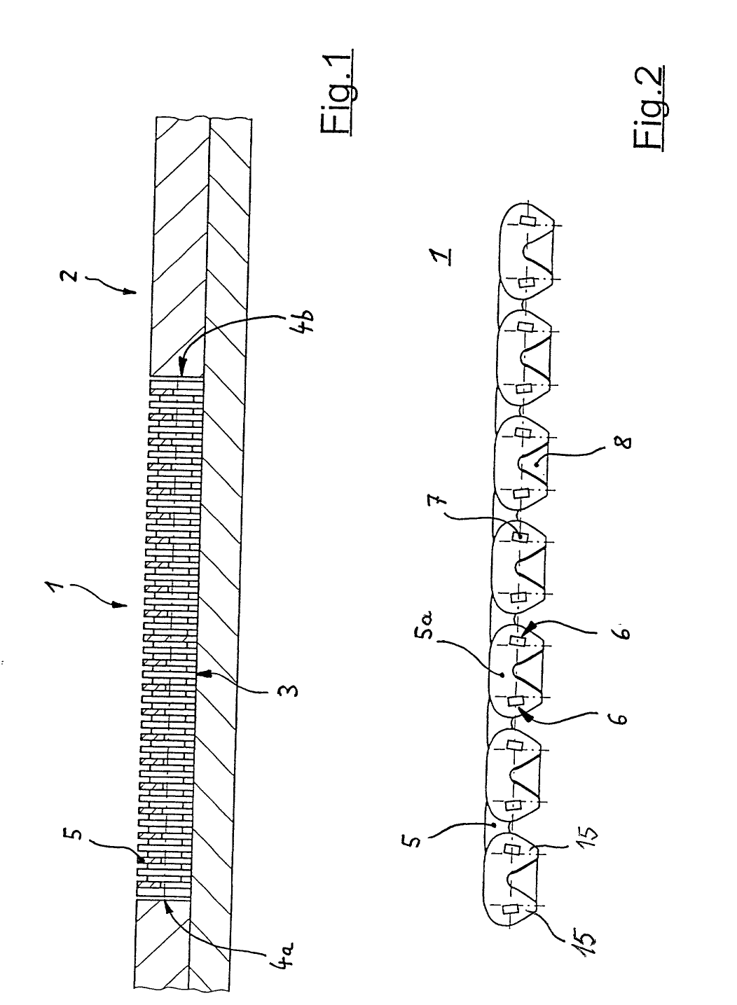

Turning now to the drawing, and in particular to FIG. 1, there is shown a cross sectional illustration of a chain conveyor having incorporated therein an inverted tooth chain according to the present invention, generally designated by reference numeral 1. The tooth chain 1 is endless and travels along an elongate carrier frame 2, which is made of steel. In the non-limiting example of FIG. 1, the tooth chain 1 is shown by way of its upper strand, which is guided within a slide bed of the carrier frame 2. The slide bed includes a flat bottom 3 and two lateral upright sidewalls 4a, 4b extending vertically from the bottom 3. The tooth chain 1 is guided with little clearance inside the slide bed and includes a plurality of double-toed links 5 which are made of steel and pinned together with adjacent outer links 5a of steel, as shown in FIG. 2, to form the tooth chain 1.

The links 5 and outer links 5a are of identical construction but have been distinguished by the use of the lower case character “a” to indicate their different location in the tooth chain 1. Hence, description of the links in detail will primarily refer to the links 5 hereinafter.

Each link 5 is of the double-toed type with two toes 15 which are spaced from one another to define tooth space 8 therebetween to consecutively engage a complementary tooth space of a sprocket, not shown. The tooth space 8 is hereby designed as involute tooth gearing. The link 5 is formed with two apertures 6 which receive pins 7 for joining together the links 5 and the outer links 5a. Each pin 7 may be configured in the form of a conventional hinge bolt, as shown in FIG. 5, and include a cradle pin part 7a and a bearing pin part 7b, whereby the bearing pin part 7b is secured at its pin end 11 to the outer link 5a, not shown in FIG. 5. Both, the profiled cradle pin part 7a and the bearing pin part 7b are received in the apertures 6 of the link 5. As the tooth chain 1 travels during operation and the jointed connection of the pin 7 moves, the profiled pin parts 7a, 7b roll off one another, without encountering a sliding friction in the cradle joint so that wear is kept small in this region.

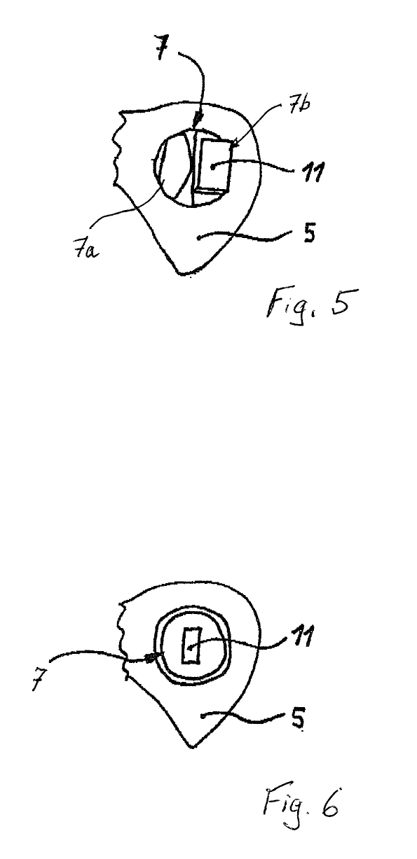

As an alternative to the hinge bolt configuration, the pin 7 may also be configured as a round bolt, as shown by way of example in FIG. 6.

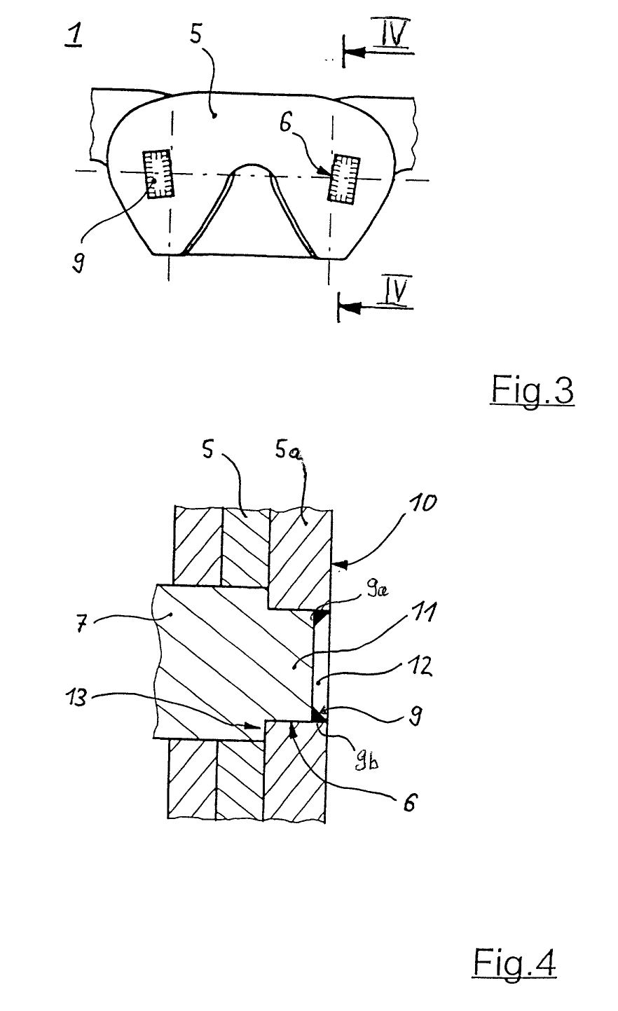

As shown in more detail in FIG. 3, the apertures 6 of each outer link 5a have each a cross sectional profile which is suited to the cross sectional profile of the end zone of the pin 7 at slight clearance fit. The pin 7 is joined to the outer link 5a by a weld seam 9, which is closed and extends annularly within the inner edge of the aperture 6.

As shown in FIG. 4, the weld seam 9 is so applied as to be prevented from protruding beyond the surface 10 of the outer link 5a, and has a substantially triangular cross section, whereby one weld seam side 9a interacts with the end face of the pin end 11, and a neighboring weld seam side 9b, which extends essentially perpendicular to the weld seam side 9a, interacts with the wall of the aperture 6. In this way, a stable connection between the pin 7 and the outer link 5a is effected for holding the other inner links 5 together. As clearly shown in FIG. 4, the pin 7 is so sized that the pin end 11 terminates at a location which is set back or recessed with respect to the outer surface 10 of the outer link 5a so that a recess or space 12 is defined within the aperture 6. The space 12 has a depth sufficiently dimensioned to allow implementation of a large enough welding seam 9. In order to ensure a constant depth of penetration of the pin end 11 in the aperture 6, the pin 7 is formed with a shoulder 13 to serve as stop member, when impacting a confronting wall portion of the outer link 5a.

Although not shown in the drawing, the tooth chain may have integrated therein additional components, such as running rollers and/or accumulating rollers to meet particular transport functions.

While the invention has been illustrated and described as embodied in a tooth chain, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A tooth chain, in particular transport tooth chain, comprising:
a plurality of links, each link having at least two spaced-apart apertures;
a plurality of pins received in the apertures for joining together the links to thereby define an inner link and an outer link, whereby the pins and the apertures are placed into one-to-one correspondence, each said pin having a length which is sized to terminate within the aperture of the outer link,
wherein the aperture has a cross sectional profile which corresponds to a cross sectional profile of a pin end at a slight clearance fit to leave a space sufficient to allow the pin end to be joined with a wall of the aperture, without projecting beyond an outer surface of the outer link.

2. The tooth chain of claim 1, wherein the pin end is joined with the outer link by a weld seam.

3. The tooth chain of claim 2, wherein the weld seam is so interrupted that at least one welding spot or at least a weld seam section is applied within the space.

4. The tooth chain of claim 2, wherein the weld seam has an annular closed configuration within the space.

5. The tooth chain of claim 2, wherein the weld seam has a substantially triangular cross section and is defined by a first weld seam side, which interacts with an end face of the pin end, and a second weld seam side, which is disposed perpendicular to the first weld seam side and interacts with the wall of the aperture.

6. The tooth chain of claim 1, wherein the pin end is joined with the outer link through riveting in the form of a graining to realize an edge widening of the pin end to form a press fit with the aperture.

7. The tooth chain of claim 1, wherein the pin has a shoulder for defining a penetration depth of the pin end in the aperture of the outer link.

8. The tooth chain of claim 1, wherein the pin is configured in the form of a round bolt or a hinge bolt.

9. The tooth chain of claim 1, wherein the outer link is thicker in width than the inner link so as to maximize an available effective depth of the space for joining the pin to the outer link.

10. A chain conveyor, comprising:
a driving sprocket;
an elongate carrier frame forming a slide bed which includes a flat bottom and two lateral upright sidewalls; and
an endless tooth chain wrapped about the driving sprocket and guided in the slide bed of the carrier frame, wherein the tooth chain includes a plurality of links, each link having at least two spaced-apart apertures, and a plurality of pins received in the apertures for joining together the links to thereby define an inner link and an outer link, whereby the pins and the apertures are placed into one-to-one correspondence, each said pin having a length which is sized to terminate within the aperture of the outer link, wherein the aperture has a cross sectional profile which corresponds to a cross sectional profile of a pin end at a slight clearance fit to leave a space sufficient to allow the pin end to be joined with a wall of the aperture, without projecting beyond an outer surface of the outer link,
wherein the sidewalls of the carrier frame are configured to correspond to the outer links of the tooth chain.
